(19) United States
(12) Patent Application Publication
(10) Pub. No.: US 2007/0138203 A1
(43) Pub. Date: Jun. 21, 2007

(54) Dye meter

(76) Inventor: Alessandro Sacchet, Alba (IT)

Correspondence Address: SHELDON MAK ROSE & ANDERSON PC, 225 SOUTH LAKE AVENUE, 9TH FLOOR, PASADENA, CA, 91101, US

(21) Appl. No.: 10/597,023

(22) PCT Filed: Oct. 22, 2004
(86) PCT No.: PCT/IT04/00578

§ 371 Date: Jul. 6, 2006

(30) Foreign Application Priority Data
Jan. 13, 2004 (IT) TO2004A000012

(51) Int. Cl. B67D 5/60; B67D 5/06

(52) U.S. Cl. 222/144; 222/144.5

(57) ABSTRACT

A dye meter (1) is disclosed that is equipped with an assembly (2) for dispensing a plurality of components for making dyeing compositions, a pumping assembly (3) for supplying the dispensing assembly (2), and circuit means (21, 23) for a fluidic connection between the dispensing assembly (2) and the pumping assembly (3); the dispensing assembly (2) comprises a support body (5) defining a plurality of nozzles (7) for delivering respective components; the pumping assembly (3) comprises a plurality of pumps (40) housed into respective seats (41) obtained in the support body in such a way that the circuit means are defined by holes obtained in the support body itself.

The present invention is related to a dye meter, namely to a metering machine for preparing dyeing compositions.

In order to prepare various types of dyeing compositions, in particular paints, enamels, etc., it is. usually necessary to mix suitable amounts of different dyes to various other basic components: the accurate metering of the various components of the colouring composition, and in particular of the dyes, is essential to obtain exactly the desired colour and to ensure its reproducibility.

Dye meters are for such purpose metering machines for preparing dyeing compositions and are essentially divided into two categories: dye meters with volumetric metering and dye meters with weight metering.

Dye meters with weight metering are normally more accurate, but, since they require the weighing in succession of all components to be metered, make the process for preparing the dyeing compositions relatively slow.

On the other hand, dye meters with volumetric metering, though less accurate, allow the simultaneous metering of individual dyes, ensuring extremely short times for preparing the related compositions.

In general terms, a dye meter with volumetric metering comprises a plurality of circuits for supplying respective dyes to a mixing vessel; each supplying circuit comprises a dye tank, a circulating pump and a control valve, typically a solenoid valve, through which the dye flow is controlled, in the desired amount, to an end nozzle that delivers the dye to the mixing vessel; a control unit meters the percentages of the different components that are necessary for obtaining the chosen product in the desired colour.

Known dye meters of the type that has been briefly described herein have big sizes and particularly relevant encumbrances and, due to the number of dyes that must be supplied along circuits operating in parallel, are relatively complex and costly.

Moreover, normally the path that each component must run from the tank to the delivery point is relatively long, with a high risk of sediment and fouling formation in the duct where the component itself passes. In order to reduce such risk, it is necessary to keep the various dyes stirred, with consequent building and use problems.

Moreover, in order to avoid dye dripping problems for capillarity, it is necessary that the end parts of the ducts have relatively small sections: consequently, on one hand the dye meter operate with relatively small flow-rates, and on the other hand the solenoid valves operate under relatively high pressures.

An object of the present invention is providing a dye meter that allows solving, at least partially, the above-mentioned prior art problems. In particular, object of the present invention is providing a dye meter that can be easily and economically manufactured, with a simple and reliable use and with small weight and encumbrance.

The present invention is related to a dye meter comprising means for dispensing a plurality of components for making dyeing compositions, pumping means for supplying said dispensing means, and circuit means for the fluidic connection between said dispensing means and said pumping means, said dispensing means comprising a support body defining a plurality of nozzles for delivering said respective components, characterised in that said pumping means and said circuit means are carried by said support body of said dispensing means.

For a better understanding of the present invention, a preferred embodiment thereof is described herein below, merely as a non-limiting example, and with reference to the enclosed drawings, in which:

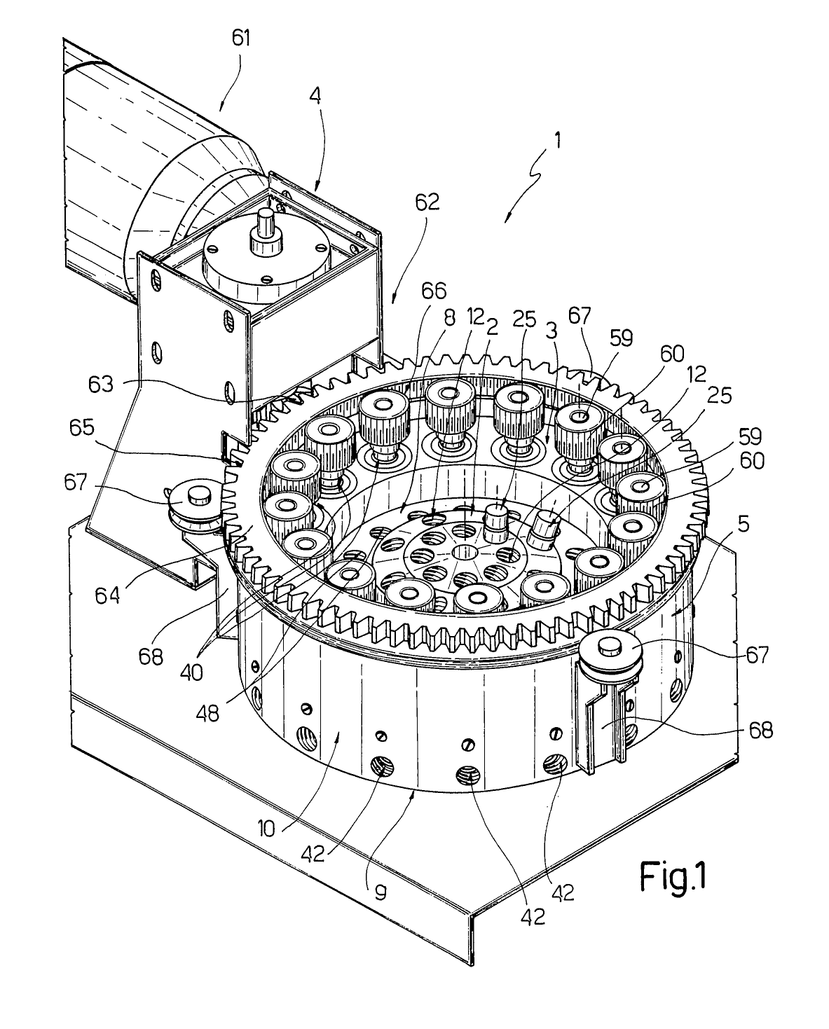

FIG. 1 is a perspective view of a dye meter realised according to the present invention, with parts removed for clarity;

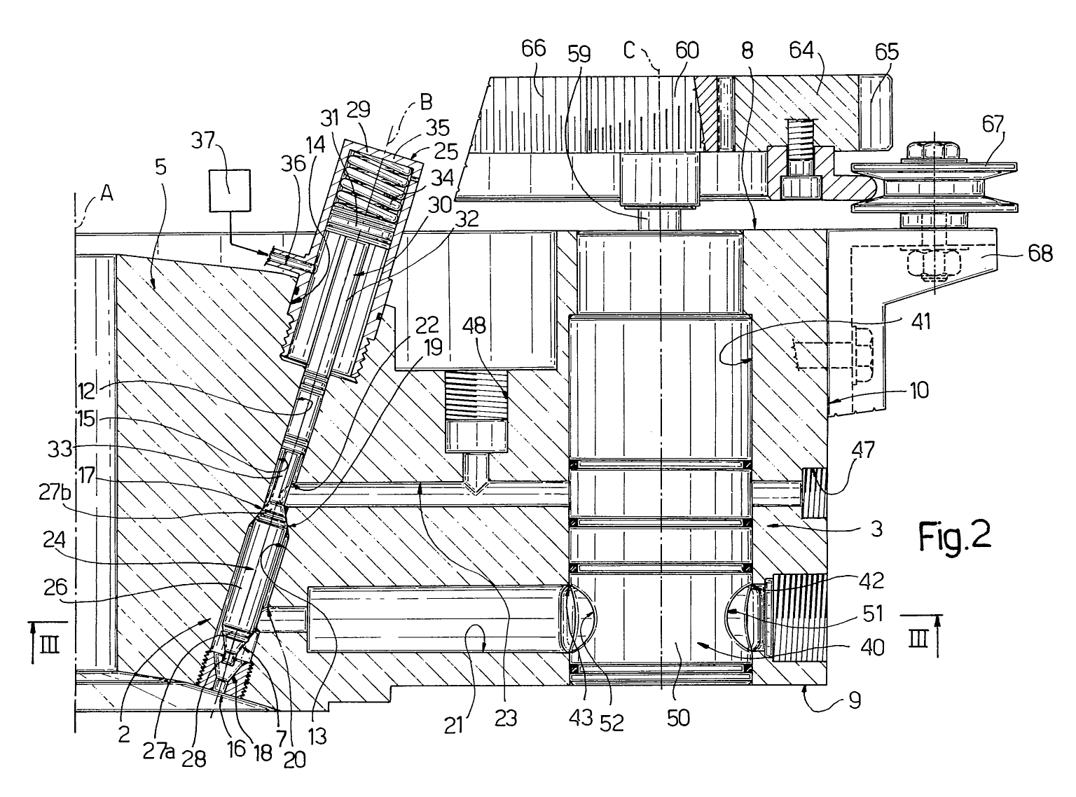

FIG. 2 is a diameter view in an enlarged scale of a part of the dye meter of FIG. 1; and

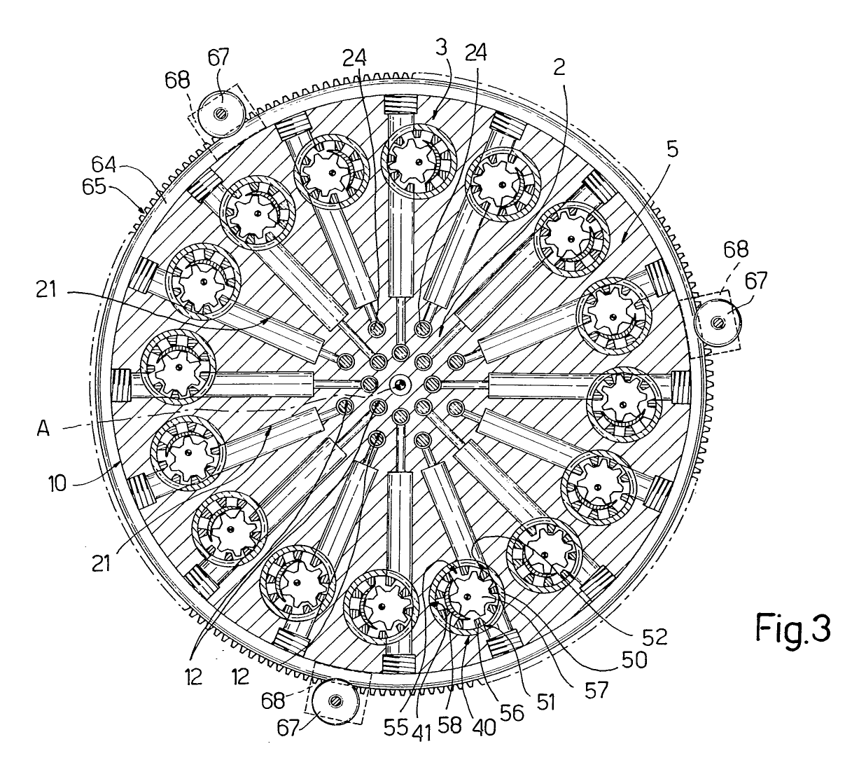

FIG. 3 is a sectional view in a reduced scale according to line III-III in FIG. 2.

With reference to FIG. 1, 1 globally designates a dye meter or metering machine for preparing dyeing compositions and/or fluid of a different nature, in particular of the volumetric metering type. The dye meter 1 is shown in the enclosed figures only in what is necessary for understanding the present invention, neglecting, for clarity reasons, the reproduction of parts that have not been modified with respect to the prior art.

The dye meter 1 essentially comprises a dispensing assembly 2 of a plurality of components for making dyeing compositions, a pumping assembly 3 connected in a known and not shown way to a plurality of tanks (also not shown) for accumulating the above components and adapted to supply the dispensing assembly 2, and a driving unit 4 for controlling the pumping assembly 3.

With reference to the enclosed figures, the dispensing assembly 2 essentially comprises a support body 5 with central symmetry, in particular a substantially cylindrical body with axis A, and a plurality of nozzles 7 obtained inside the support body 5 and each aimed to deliver a related component.

In particular, the support body 5 is externally bounded by a pair of respectively upper and lower base surfaces 8, 9, with reference to FIGS. 1 and 2, which are arranged substantially orthogonal to axis A, and by a side surface 10.

The support body 5 is equipped with a plurality of seats 12 arranged passing between the two base surfaces 8, 9, angularly arranged around axis A and defining, next to the lower base 9, the respective delivering nozzles 7 for the various components for making the dyeing compositions.

In the embodiment shown, the seats 12, and with them, the related nozzles 7 are arranged around the central axis A according to a pair of concentric rings, in order to optimally exploit the available space. More precisely, the seats 12 forming one of the two rings are angularly offset with respect to the seats 12 forming the other ring.

With particular reference to FIG. 2, the seats 12 have respective axes B that are mutually converging and slanted with respect to the central axis A towards the lower base surface 9 of the support body 5.

Each seat 12 is essentially composed of a pair of cylindrical chambers 13, 14 having a different diameter and arranged adjacent to the respective base surfaces 9, 8, and of a hole or intermediate duct 15 that mutually connects the chambers 13 and 14 and having a smaller diameter with respect to both of them.

In particular, the chamber 13 has a smaller diameter with respect to the diameter of chamber 14, faces, at one of its axial ends, the base surface 9 through an outlet opening 16 for delivering the related component and ends, next to its opposite axial end, into the intermediate duct 15 through a service opening 17.

The outlet opening 16 and the service opening 17 have a smaller diameter than the diameter of the chamber 13 and are connected to the chamber 13 itself through tapered fittings defining respective sealing sections 18, 19.

The chamber 13 moreover has laterally a radial inlet opening 20 connected, through a duct 21 for supplying the related component (described in more detail below), to the pumping assembly 3.

Advantageously, the inlet opening 20 is arranged in closed proximity with the outlet opening 16 and defines, with this latter one and with the part of chamber 13 included between them, a related nozzle 7.

The chamber 14 faces outside the part of the base surface 8 and communicates with the intermediate duct 15 on the opposite part.

The intermediate duct 15 is laterally equipped, next to the service opening 17, with a radial re-circulation opening 22 connected, through a re-circulation duct 23 (described in more detail below), to a re-circulation circuit of a known and not shown type.

Each seat 12 and, consequently, each nozzle 7 are associated with a related moving shutter 24 and to an actuator member 25, in this case of the type with pneumatic or hydraulic actuation, operating on the shutter 24 itself in order to alternatively make it close and open its respective nozzle 7.

Each shutter 24 comprises a main cylindrical body 26 that is able to axially slide in the chamber 13 and opposite axial, tapered end portions 27a, 27b adapted to fluid-sealingly cooperate respectively with the sealing sections 18, 19 connecting the chamber 13 itself to the outlet opening 16 and the service opening 17. The end portion 27a carries a closing cylinder 28 that can be inserted in the outlet opening 16.

In the embodiment shown, the actuator member 25 is composed of a pneumatic or hydraulic cylinder having an external liner 29 removably housed inside the chamber 14 and projecting from the base surface 8, and of a plunger 30 movable with respect to the liner 29 and integrally connected with the shutter 24.

In particular, the plunger 30 comprises a disk-shaped piston 31 adapted to sealingly slide inside the liner 29, and a stem 32, which projects from the piston 31 itself, is axially fluid-sealingly sliding assembled in the intermediate duct 15, and is housed passing through the service opening 17.

The stem 32 is connected to the shutter 24 through a length 33 of a reduced diameter having a radial clearance with respect to the intermediate duct 15.

In practice, opposite longitudinal ends of the stem 32 are respectively integral with the end portion 27b of the shutter 24 and with the piston 31.

The plunger 30 is charged by a resilient member 34, for example a helical spring, placed between piston 31 and a bottom wall 35 of the liner 29 opposite to the one from which the stem 32 goes out.

The liner 29 has, along its own side wall, a hole 36 for entering the operating fluid communicating with a pneumatic or hydraulic activation circuit 37 (known and only schematically shown in FIG. 2): the entry hole 36 is arranged on the part of a face of the piston 31 opposite to the one on which the resilient member 34 operates, so that the operating fluid entered inside the liner 29 operates on the piston 31 against the action of the resilient member 34 itself.

The pumping assembly 3 comprises a plurality of hydraulic pumps 40, of the type commonly known with “VIKING” (Registered Trademark) denomination with internal gears, each one connected to a related seat 12 and, therefore, to a related nozzle 7 through supply duct 21 and re-circulation duct 23.

According to an important aspect of the present invention, the pumps 40 are housed into respective seats 41 obtained in the support body 5 in such a way that the supply duct 21 and the re-circulation duct 23 are defined by holes obtained in the support body 5 itself.

In particular, the seats 41 are obtained passing between the base surfaces 8 and 9, has respective axes C orthogonal to the base surfaces 8, 9 themselves and are also angularly arranged around axis A in a radially external position with respect to the seats 12.

As clearly visible in FIGS. 1 and 3, the seats 12 and the seats 41 are arranged according to concentric rings around the central axis A.

Each seat 41 (FIG. 2) has, in an adjacent position to the base surface 9, a radial inlet opening that can be connected to the tank of the related component and a delivery opening 43 that is also radial and is connected, through the supply duct 21, to the inlet opening 20 of the chamber 13 of a related seat 12.

In particular, the inlet and delivery openings 42, 43 associated with each seat 41 and the inlet opening 20 of the seat 12 connected to the seat 41 itself extend at the same axial height of the support body 5 and are arranged along the same radial direction with respect to axis A. More precisely, the inlet and delivery openings 42, 43 associated with each seat 41 extend from opposite sides of axis C and are oriented respectively towards the side surface 10 of the support body 5 and towards the related seat 12.

Due to the described arrangement, the supply duct 21 connecting each seat 41 with a related seat 12, or better the delivery opening 43 of each seat 41 with the inlet opening 20 of the associated seat 12, has a radial extension inside the support body 5.

The support body 5 moreover defines, for each pair of seats 12 and 41, a connection 48 for the re-circulation circuit, which is obtained in an interposed position between the seats 12 and 41 themselves and extends passing between the re-circulation duct 23 and the base surface 8, and a connection 47 for a rotation-preventing locking dowel (known per se and not shown) of the related pump 40, which connection faces the side surface 10 and extends along the same direction of the re-circulation duct 23 between the side surface 10 and the pump 40.

With particular reference to FIGS. 2 and 3, each pump 40 comprises, in a known way, an external cylindrical body 50 that is coaxially housed inside a related seat 41 and is equipped with inlet mouths 51 and delivery mouths 52 arranged next to the respective inlet openings 42 and delivery openings 43, and a rotor assembly 55 composed of a pair of gears, respectively a toothed crown 56 and a gear 57 with external teeth, that are mutually meshing (FIG. 3).

The toothed crown 56 extends coaxially with axis C, is supported in an axially fixed position and in an angularly rotating way inside the body 50, and is equipped with a plurality of teeth that are axially projecting from an upper ring (not visible in the enclosed figures) and that mutually delimit respective through-openings in order to allow the inlet and outlet flow of the related component next to the inlet mouth 51 and the delivery mouth 52.

The toothed crown 56, moreover, is keyed onto an axial end of a drive shaft 59, whose opposite axial end externally sealingly projects from the body 50 and integrally carries a related gear 60 for receiving motion from the driving unit 4, as will be explained in more detail below.

The gear 57 with external teeth is supported in an axially fixed position and in an angularly rotating way from the body 50 in order to be able to be dragged in rotation by the toothed crown 56. As can be seen in FIG. 3, the gear 57 is assembled eccentric inside the toothed crown 56 in order to delimit, with this latter one, variable volumes when rotating.

For a prefixed rotating arc of the toothed crown 56 and the gear 57, a fixed sector 58 keeps the low-pressure area (adjacent to the inlet mouth 51) separate from the high-pressure area (adjacent to the delivery mouth 52).

With reference to the enclosed figures, the driving unit 4 comprises an electrically-operated driving assembly 61 and a geared transmission assembly 62 to transfer motion from the driving assembly 61 itself to the drive shafts 59 of the pumps 40.

The transmission assembly 62 comprises a pinion 63 (partially visible in FIG. 1) actuated by the driving assembly 61, a toothed crown 64 that is externally assembly on the support body 5 in order to be able to rotate around axis A and equipped with an external toothing 65 meshing with the pinion 63 and with an internal toothing 66 meshing with the gears 60 associated with the pumps 40.

In particular, the toothed crown 64 extends in a position facing the base surface 8 of the support body 5 and is axially and rotatingly supported by three circular, driving sliders 67 that are mutually angularly and equally spaced around axis A and projectingly secured to respective brackets 68 radially projecting from the side surface 10 of the support body 5 itself.

The operation of the above-described dye meter 1 is as follows.

Upon every activation of the driving unit 61, all pumps 40 are simultaneously actuated by the rotating dragging of the toothed crown 64 by means of the pinion 63. Each component flows from the related tank inside the related pump 40 and, from this, is pushed, through the delivery mouth 52, into the supply duct 21 in order to reach the inlet opening 20 of the related seat 12.

When a nozzle 7 must not deliver the respective component of the dyeing composition to be prepared, the respective shutter 24 is kept from the resilient member 34 in a closing position of the nozzle 7 itself. In such position, the end portion 27a of the shutter 24 closes the sealing section 18 of the related seat 12 and the closing cylinder 28 engages the outlet opening 16; in this way, the component that is present in the supply duct 21 cannot be delivered.

Moreover, in the closing position of the shutter 24, the end position 27b is at a pre-established distance from the sealing section 19 and enables the flow through the service opening 17. The material remained inside the chamber 13 can be recovered through the suitable re-circulation circuit: such material, in fact, can pass from the chamber 13 in the re-circulation duct 23 and, through the connection 48, in the real re-circulation circuit.

When the nozzle 7, instead, must deliver the respective component, the activation circuit 37 enters operating fluid through the entry hole 36 inside the liner 29 of the related actuator 25, acting on the piston 31 against the action of the resilient member 34, as shown in FIG. 2: the plunger 30 is therefore displaced taking the shutter 24 in an opening position of the nozzle 7. In this position, the end portion 27a is spaced from the sealing section 18 and thereby enables the flow through the outlet opening 16, while the end portion 27b closes the sealing section 19 and, with it, the service opening 17: the component being present in the supply duct 21 is therefore delivered by the nozzle 7 through the outlet opening 16.

In this way, each shutter 24 is therefore taken by its related actuator 25 to alternatively cooperate with the sealing section 18 or with the sealing section 19 to alternatively open/close the outlet opening 16 and the service opening 17: in other words, the end portion 27a of each shutter 24 is selectively brought to open/close the related outlet opening 16, and at the same time the end portion 27b is brought to close/open the related service opening 17.

From what has been described, it is clear how the dye meter 1 realised according to the present invention solves the prior art problems that have been previously pointed out, being at the same time able, as a whole, to be easily and economically manufactured and to be easily, efficiently and reliably operated.

In particular, the arrangement of the pump 40 directly on the support body 5 of the dispensing assembly 2 allows obtaining a high compactness of the dye meter 1, reducing global encumbrances and weights and simplifying the supply and re-circulation circuits of the components for producing dyeing compositions.

Moreover, the pumps 40, arranged on a radially external ring that is concentric with those on which the delivery nozzles 7 are located, can be taken in a nearby position to the nozzles 7 themselves, with consequent reduction of the length of the supply duct 21 and the re-circulation duct 23 and of the risks of forming sediments, fouling and pressure in such ducts.

It is finally clear that modifications and variations can be made to the described and shown dye meter 1, without departing from the scope of the invention as defined by the claims.

1. A dye meter comprising means for dispensing a plurality of components for making dyeing compositions, pumping means for supplying the dispensing means, and circuit means, for a fluidic connection between the dispensing means and the pumping means, the dispensing means comprising a support body defining a plurality of nozzles for delivering the respective components, wherein the pumping means and the circuit means are carried by the support body of the dispensing means.

2. The dye meter of claim 1, wherein the nozzles are angularly arranged around a central axis of the support body, and wherein the pumping means comprise a plurality of pumps housed inside respective seats of the support body, that are also angularly arranged around the central axis.

3. The dye meter of claim 2, wherein the circuit means comprise a plurality of ducts obtained in the support body and connecting the seats for housing the pumps with the nozzles.

4. The dye meter of claim 2, wherein the seats for the pumps and the nozzles are arranged in concentric rings around the central axis.

5. The dye meter of claim 4, wherein the seats for the pumps are radially external with respect to the nozzles with reference to the central axis.

6. The dye meter of claim 2, wherein the nozzles are arranged with respective axes that are mutually converging and slanted with respect to the central axis of the support body.

7. The dye meter of claim 3, wherein the ducts for connecting the seats for the pumps with the nozzles have a radial extension with respect to the central axis.

8. The dye meter of claim 2, further comprising a driving unit for simultaneously activating the pumps, and a shutter for each one of the nozzles that is adapted to be selectively moved independently from the other shutters between an opening position, in which it allows delivering the related component from the related nozzle, and a closing position of the nozzle.

9. The dye meter of claim 8, wherein each one of the pumps comprises a rotor that is angularly integral with a related gear, and wherein the driving unit comprises a toothed crown carried by the support body in such a way as to be able to rotate around the central axis and having an internal toothing meshing with the gears.
